(19) United States
(12) Patent Application Publication
(10) Pub. No.: US 2019/0101068 A1
(43) Pub. Date: Apr. 4, 2019

(54) A METHOD AND A SYSTEM FOR ADAPTING ENGINE CONTROL OF A GAS ENGINE IN A VEHICLE

(71) Applicant: Scania CV AB, Södertälje (SE)

(72) Inventor: Mårten Wallengren, Tullinge (SE)

(73) Assignee: Scania CV AB, Södertälje (SE)

(21) Appl. No.: 16/085,980

(22) PCT Filed: Mar. 20, 2017
(86) PCT No.: PCT/SE2017/050264

§ 371 Date: Sep. 17, 2018

(30) Foreign Application Priority Data
Mar. 23, 2016 (SE) 1650386-4

(51) Int. Cl. F02D 19/02; F02D 41/00; F02D 41/14; F02D 41/18

(52) U.S. Cl. CPC F02D 19/024; F02D 19/027; F02D 19/022; F02D 19/029; F02D 41/0027; F02D 2200/0612; F02D 41/182; F02D 2200/0406; F02D 2200/0414; F02D 2200/0602; F02D 41/1454

(57) ABSTRACT

The present invention relates to a method for adapting engine control of a gas engine in a vehicle. The method comprises determining, during operation of the gas engine, the specific gas constant of a fuel gas for the gas engine. The method further comprises determining the stoichiometric air fuel ratio of the fuel gas for the gas engine. The control of the gas engine is adapted based on the determined specific gas constant and the determined stoichiometric air fuel ratio. The present invention also relates to a system for adapting engine control of a gas engine in a vehicle, to a vehicle, and to a computer program product.

### CROSS-REFERENCE TO RELATED APPLICATION(S)

This application is a National Stage Application (filed under 35 § U.S.C. 371) of PCT/SE2017/050264, filed Mar. 20, 2017 of the same title, which, in turn claims priority to Swedish Application No. 1650386-4 filed Mar. 23, 2016 of the same title; the contents of each of which are hereby incorporated by reference.

### FIELD OF THE INVENTION

The present invention relates to a method and a system for adapting engine control of a gas engine in a vehicle. The present relation also relates to vehicle, to a computer program product for adapting engine control of a gas engine in a vehicle.

### BACKGROUND OF THE INVENTION

The exhaust aftertreatment of a spark ignited engine running stoichiometric consists often of a three-way catalytic converter in the exhaust system. A three-way catalytic converter must be in chemical balance to be able to reduce nitrogen-oxides emissions and oxidize carbon-monoxide and hydrocarbon emissions. A modern engine management system, EMS, adapts to different fuel qualities by adjusting the air-fuel ratio, AFR, until a so-called stoichiometric ratio could be measured. This is usually done by means of a so-called lambda sensor situated in the exhaust pipe relatively close to the engine. The lambda sensor measures the ratio of actual AFR to stoichiometric AFR. This ratio is usually denoted λ. The EMS then controls the fuel injection by adding or reducing the fuel in relation to the air going in to the engine. This is done by a control algorithm called lambda controller.

For petrol as the fuel this works very well and can compensate for different energy contents in the fuel. It also compensates for if some components like fuel injectors, air mass meters or other components involved in calculating air or fuel, are not nominal to their specification. The value of the lambda controller is then saved as an adaptation in the flash memory of an electronic control unit, ECU. This means that the value of the lambda controller can be used next time engine is started. When fuel is stable and all components are functioning properly the adjustments made by the lambda controller are relatively small.

For gaseous fuels a similar control is used.

Problems relating to different fuel qualities of petrol are basically related to different evaporation properties of the petrol. Functions of the EMS relating to different evaporation properties are of no need for gaseous fuels since gaseous fuels do not need to be evaporated.

### SUMMARY OF THE INVENTION

Whereas the energy content of petrol usually only differs by ±1-2 MJ/kg, the energy content of gaseous fuel can differ by around ±5 MJ/kg. Whereas the density of petrol usually only differs with a few percent, the density of gaseous fuels can differ by up to 20%. As a result, the stoichiometric AFR of gaseous fuels can differ considerably. As an example, methane has a stoichiometric AFR of 17.2, while some natural gas on the market has a stoichiometric AFR of 13.1. As a further result, the specific gas constant can be different. While methane has a specific gas constant of around 520 in the international system of units, SI-units, said natural gas on the market has a specific gas constant of around 450 in SI-units.

The solution of using a similar EMS for gaseous fuels as for petrol, i.e. using basically the lambda controller for adjusting differences between different gases, has some drawbacks. The difference between different gases can be so large that it can be difficult to manage the adjustments between the limits of the lambda controller.

The idea of having the standard fuel adaptation in the system is to correct for differences in the hardware of the components involved in the fuel injection and lambda control, such as injectors and lambda sensors. If the fuel adaptation shall handle both quality differences between gaseous fuels and hardware the risk of going outside the limits and getting an engine malfunction will be much higher.

A further drawback of the solution is that the effect of the gas quality on the air mass calculation will be completely ignored. Even though λ will be correct the amount of air calculated could be wrong. This affects the calculated torque and also the ignition angle used, which risks running the engine on an ignition angle which is not optimal and calculating an incorrect torque which could affect the drivability in a negative way.

There is thus a need for improving the adaption of an engine control for gaseous fuels.

It is thus an object of the present invention to provide a method, a system, a vehicle, a computer program and a computer program product for improved adaption of an engine control for gaseous fuels.

It is further an object of the present invention to provide an alternative method, a system a vehicle, a computer program and a computer program product for adaption of an engine control for gaseous fuels.

At least parts of the objects are achieved by a method for adapting engine control of a gas engine in a vehicle. The method comprises determining, during operation of the gas engine, the specific gas constant of a fuel gas for the gas engine. The method further comprises determining the stoichiometric air fuel ratio of the fuel gas for the gas engine. The control of the gas engine is adapted based on the determined specific gas constant and the determined stoichiometric air fuel ratio. This has the advantage that better fuel efficiency can be achieved. Also the composition of the exhaust mix from the gas engine can be optimized. By this some compositions in the exhaust can be minimized, which reduces negative effects on the environment. The method can also result in less wear of components in the gas engine and thus to a longer lifetime of these components.

In one example of the method the determining of the specific gas constant and/or the stoichiometric air fuel ratio is based on a determined time period of gas injection. The time period of the gas injection is easy to determine. This results in an easy implementation of the method.

In one example the method further comprises performing measurements in the vehicle. The determining of the specific gas constant and/or the determining of the stoichiometric air fuel ratio is based on a result of the performed measurements. Using measurements for the method improves the flexibility of the method for a large variety of fuel gases. Further, better results can be achieved compared to basing parameters on assumptions.

In one example the performed measurements comprise measuring a pressure value and a temperature value in the inlet manifold. Sensors for providing these value exist in many nowadays vehicles. Thus, an implementation of the method in present vehicles without the need of new or additional hardware is facilitated. Not needing new hardware is an especially cost effective implementation of the method.

In one example the performed measurements comprise measuring a temperature value and/or a pressure value of the fuel gas upstream of a gas injector. Sensors for providing these value exist in many nowadays vehicles. Thus, an implementation of the method in present vehicles without the need of new or additional hardware is facilitated. Not needing new hardware is an especially cost effective implementation of the method.

In one example the performed measurements comprise measuring a λ value by means of a lambda sensor. The lambda sensor is provided downstream the gas engine. A lambda sensor is standard in many nowadays vehicles. Thus, an implementation of the method in present vehicles without the need of new or additional hardware is facilitated. Not needing new hardware is an especially cost effective implementation of the method.

In one example the method further comprises determining a flow of air into the gas engine and/or determining a mass of air in a cylinder of the gas engine. The determining of the specific gas constant and/or the stoichiometric air fuel ratio is based on the determined flow of air into the gas engine and/or the determined mass of air in the cylinder of the gas engine. This determination can be implemented in many different ways. An implementation of this determination is often possible in nowadays vehicles without the need of additional hardware. Not needing new hardware is an especially cost effective implementation of the method.

At least parts of the objects are achieved by a system for adapting engine control of a gas engine in a vehicle. The system comprises means for determining, during operation of the gas engine, the specific gas constant of a fuel gas for the gas engine. The system further comprises means for determining the stoichiometric air fuel ratio of the fuel gas for the gas engine. The system even further comprises means for adapting the control of the gas engine based on the determined specific gas constant and the determined stoichiometric air fuel ratio.

In one embodiment the system further comprises means for determining a time period of gas injection per working cycle of the engine. The means for determining the stoichiometric air fuel ratio of the fuel gas for the gas engine and/or the means for determining, during operation of the gas engine, the specific gas constant of a fuel gas for the gas engine are then arranged for basing the determining of the stoichiometric air fuel ratio and/or the specific gas constant on the determined time period of gas injection.

In one embodiment the system further comprises means for performing measurements in the vehicle. The means for determining the specific gas constant and/or the means for determining the stoichiometric air fuel ratio are then arranged to base the determining on a result of the performed measurements.

In one embodiment the means for performing measurements comprise means for measuring a pressure value and a temperature value in the inlet.

In one embodiment the means for performing measurements comprise means for measuring a temperature value and/or a pressure value of the fuel gas upstream of a gas injector.

In one embodiment the means for performing measurements comprise a lambda sensor which is arranged downstream the gas engine. The lambda sensor is arranged for measuring a λ value.

In one embodiment the system further comprises means for determining a flow of air into the gas engine and/or means for determining a mass of air in a cylinder of the gas engine. The means for determining the specific gas constant and/or the means for determining the stoichiometric air fuel ratio are arranged for basing said determining of the specific gas constant and/or the stoichiometric air fuel ratio on the determined flow of air into the gas engine and/or the determined mass of air in the cylinder of the gas engine.

At least some of the objects of the present invention are achieved by a vehicle which comprises a system for adapting engine control of a gas engine in a vehicle according to the present disclosure.

At least some of the objects of the present invention are achieved by a computer program for adapting engine control of a gas engine in a vehicle. The computer program comprises program code for causing an electronic control unit or a computer connected to the electronic control unit to perform the steps of the method for adapting engine control of a gas engine in a vehicle according to the present disclosure.

At least some of the objects of the present invention are achieved by a computer program product containing a program code stored on a computer-readable medium for performing method steps according to a method for adapting engine control of a gas engine in a vehicle according to the present disclosure. This is done when the computer program is run on an electronic control unit or a computer connected to the electronic control unit.

The system, the vehicle, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, a system according to one embodiment of the present invention;

FIG. 3 shows, in a schematic way, a flow chart over an example of a method according to the present invention; and

FIG. 4 shows, in a schematic way, a device which can be used in connection with the present invention.

### DETAILED DESCRIPTION OF THE INVENTION

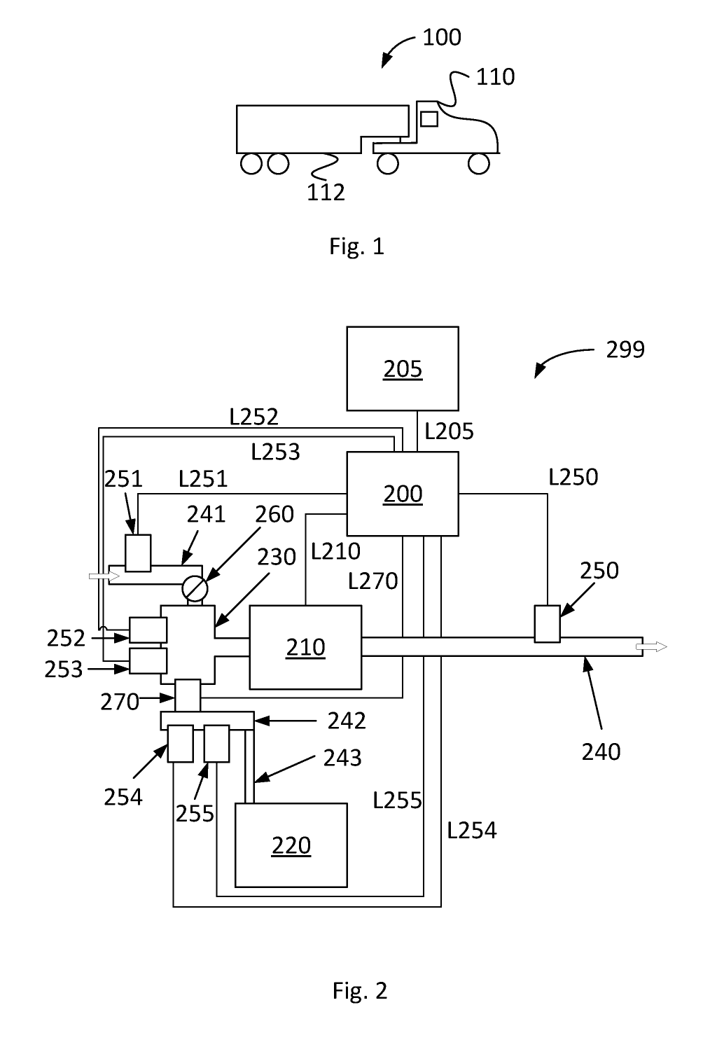

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 comprises a gas engine. The vehicle 100 comprises a system 299, se FIG. 2a. The system 299 can be arranged in the tractor unit 110.

In one example, the vehicle 100 is a bus. The vehicle 100 can be any kind of vehicle comprising a gas engine. Other examples of vehicles comprising a gas engine are boats, passenger cars, construction vehicles, and locomotives. The present invention can also be used in connection with any other platform than vehicles, as long as such a platform comprises a gas engine.

The innovative method and the innovative system according to one aspect of the invention are also well suited to, for example, systems which comprise industrial engines and/or engine-powered industrial robots.

The term “link” refers herein to a communication link which may be a physical connection such as an optical, electrical, or opto-electronic communication line, or a non-physical connection such as a wireless connection, e.g. a radio link or microwave link.

FIG. 2 shows schematically an embodiment of a system 299 for adapting engine control of a gas engine in a vehicle according to the present invention. The system 299 comprises a gas engine 210. The gas engine 210 can be arranged to propel a vehicle. The gas engine 210 comprises at least one cylinder. Each cylinder has a corresponding volume of the cylinder, V_{cyl}. In the following it is assumed that the volumes of the cylinders are equal. However, it should be understood that the present invention easily could be adapted to cylinders of different volumes by defining different volumes V_{cyl}_{_}ₙ for a specific cylinder n. The value V_{cyl} relates to a volume in the cylinder in which air and/or fuel can be injected at a pre-determined position of a piston in the cylinder. In one example, the value V_{cyl} relates to the maximum possible volume of the cylinder, for example when the position of the piston is in its least extended position. The value V_{cyl} is pre-determined for a given gas engine and can be stored in a first control unit 200.

Said first control unit 200 is arranged to control operation of said gas engine 210. Said first control unit 200 is arranged for communication with said gas engine 210 via a link L210. Said first control unit 200 is arranged to receive information from said gas engine 210.

Said system 299 comprises an air inlet 241. The possible flowing direction of air into the air inlet is indicated by the white arrow. The air then passes a throttle 260 before entering an inlet manifold 230. Said throttle 260 is arranged for controlling the flow of air into said inlet manifold 230. Said throttle 260 is, for example, controlled by said first control unit 200 and/or by a pedal (not shown) of the vehicle.

Said system 299 further comprises a tank 220. Said tank 220 is arranged for storing the fuel gas of the vehicle. The fuel gas can, for example, be compressed natural gas, CNG. It should, however, be noted that the invention is not limited to CNG but could use any suitable gas which can act as a fuel gas for the gas engine 210. The tank 220 is connected via connecting means 243 to a fuel rail 242. Said connecting means 243 can comprise pipes, tubes, or the like. Said connecting means 243 are arranged for transporting the fuel gas from the tank 220 to the fuel rail 242.

The system 299 further comprises a gas injector 270. Said gas injector 270 is arranged for injecting gas from the fuel rail 242 into the inlet manifold 230. The gas is injected during a time period tᵢₙⱼ for each working cycle. Said gas injector 270 has an effective cross-sectional area, A_{CD}, of its injector nozzle.

Said first control unit 200 is arranged to control operation of said gas injector 270. Said first control unit 200 is arranged for communication with said gas injector 270 via a link L270. Said first control unit 200 can be arranged to receive information from said gas injector 270.

Said first control unit 200 can, for example, be arranged to control tᵢₙⱼ. In one example, tᵢₙⱼ is calculated by said first control unit 200. In one example, tᵢₙⱼ is measured at the gas injector 270. A_{CD} can be stored in said first control unit 200.

Said system 299 further comprises an exhaust pipe 240. Said exhaust pipe 240 is connected to the gas engine 210 and arranged to transport exhausts from the gas engine 210 into the environment as indicated by the white arrow. It should be understood that means for treating the exhaust (not shown) can be arranged along the exhaust pipe. Such means are for example catalytic means for exhaust treatment.

Said system 299 further comprises a lambda sensor 250. Said lambda sensor 250 is provided downstream said gas engine 210. Said lambda sensor 250 is provided at said exhaust pipe 240. Said lambda sensor 250 is arranged to perform a measurement of λ, i.e. the ratio between actual air-fuel ratio, AFR, and stoichiometric air-fuel ratio, AFRₛ.

Said first control unit 200 is arranged to control operation of said lambda sensor 250. Said first control unit 200 is arranged for communication with said lambda sensor 250 via a link L250. Said first control unit 200 can be arranged to receive information from said lambda sensor 250.

Said system 299 further comprises first means for measuring a temperature value. Said first means for measuring a temperature value can be a first temperature sensor 254. Said first temperature sensor is arranged upstream said gas injector 270. Here, the term “upstream” should be understood in the sense that said first temperature sensor 254 is arranged for measuring the temperature Tᵣₐᵢₗ of the fuel gas before it passes the gas injector 270. In the shown example, said first temperature sensor 254 is arranged at the fuel rail 242.

Said first control unit 200 is arranged to control operation of said first temperature sensor 254. Said first control unit 200 is arranged for communication with said first temperature sensor 254 via a link L254. Said first control unit 200 can be arranged to receive information, for example Tᵣₐᵢₗ, from said first temperature sensor 254.

Said system 299 further comprises first means for measuring a pressure value. Said first means for measuring a pressure value can be a first pressure sensor 255. Said first pressure sensor is arranged upstream said gas injector 270. Here, the term “upstream” should be understood in the sense that said first pressure sensor 255 is arranged for measuring the pressure pᵣₐᵢₗ of the fuel gas before it passes the gas injector 270. In the shown example, said first pressure sensor 255 is arranged at the fuel rail 242.

Said first control unit 200 is arranged to control operation of said first pressure sensor 255. Said first control unit 200 is arranged for communication with said first pressure sensor 255 via a link L255. Said first control unit 200 can be arranged to receive information, for example pᵣₐᵢₗ, from said first pressure sensor 255.

Said system 299 further comprises second means for measuring a temperature value. Said second means for measuring a temperature value can be a second temperature sensor 252. Said second temperature sensor 252 is arranged at the inlet manifold 230. Said second temperature sensor 252 is arranged to measure the temperature Tᵢₙ in the inlet manifold 230.

Said first control unit 200 is arranged to control operation of said second temperature sensor 252. Said first control unit 200 is arranged for communication with said second temperature sensor 252 via a link L252. Said first control unit 200 can be arranged to receive information, for example Tᵢₙ, from said second temperature sensor 252.

Said system 299 further comprises second means for measuring a pressure value. Said second means for measuring a pressure value can be a second pressure sensor 253. Said second pressure sensor 253 is arranged at the inlet manifold 230. Said second pressure sensor 253 is arranged to measure the pressure pᵢₙ in the inlet manifold 230.

Said first control unit 200 is arranged to control operation of said second pressure sensor 253. Said first control unit 200 is arranged for communication with said second pressure sensor 253 via a link L253. Said first control unit 200 can be arranged to receive information, for example pᵢₙ, from said second pressure sensor 253.

Said system 299 further comprises means for determining a flow of air into the gas engine 210 and/or means for determining a mass of air in a cylinder of the gas engine 210.

In one example, said means for determining a flow of air into the gas engine 210 and/or means for determining a mass of air in a cylinder of the gas engine 210 comprise a mass air flow sensor, MAF-sensor, 251. Said MAF-sensor 251 can be a hot film air mass sensor, HFM-sensor. Said MAF-sensor 251 is arranged for measuring an air mass flow in the air inlet 241.

Said first control unit 200 is arranged to control operation of MAF-sensor 251. Said first control unit 200 is arranged for communication with said MAF-sensor 251 via a link L251. Said first control unit 200 can be arranged to receive information from said MAF-sensor 251.

In one example, said means for determining a flow of air into the gas engine and/or means for determining a mass of air in a cylinder of the gas engine comprise means for determining a flow through the throttle 260. Said means for determining a flow through the throttle 260 can, for example, comprise a third pressure sensor at the air inlet 241 and a third temperature sensor at the air inlet 241 (not shown). Said means for determining a flow through the throttle 260 can also comprise means for determining an effective area of the throttle. Said effective area relates to an effective area through which the air can flow from the air inlet 241 through the throttle. Said means for determining an effective area of the throttle can comprise a sensor for determining an angle of a throttle flap. The first control unit 200 can then be arranged to calculate the flow of air mass through the throttle based on the measurement results of at least one of said third temperature sensor, said third pressure sensor and said sensor for determining an angle of a throttle flap.

In one example, the mass of air in a cylinder of the gas engine can be determined by said first control unit 200. This can, for example, be done based on a volumetric efficiency, VE, of the cylinder and the ideal gas law. The VE is defined as the ratio of air in the cylinder when no fuel is present in relation to V_{cyl}. The VE is generally less than one since also exhaust gas residuals might be present in the volume of the cylinder. Values for the VE might be stored in said first control unit 200. In one example, said values for the VE depend on pᵢₙ and/or Tᵢₙ.

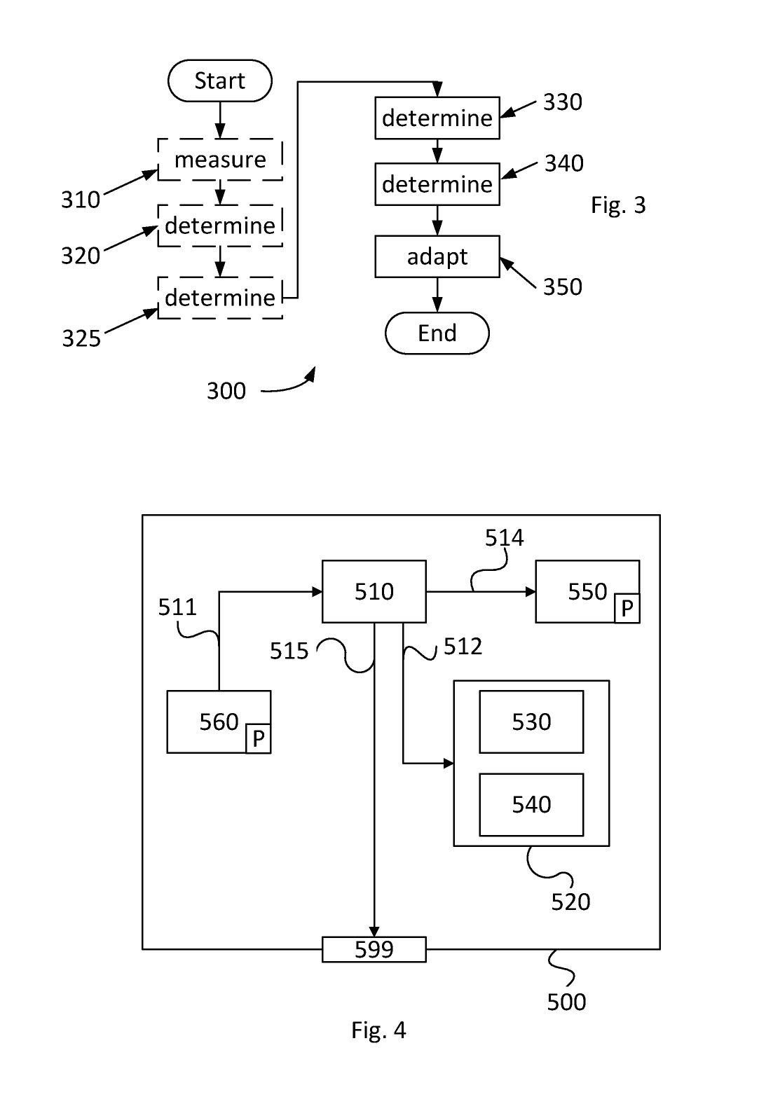

Said first control unit 200 is arranged for determining, during operation of the gas engine 210, the specific gas constant of a fuel gas for the gas engine 210. A way of doing this is described in relation to FIGS. 3 and 4.

Said first control unit 200 is arranged for determining the stoichiometric air fuel ratio of the fuel gas for the gas engine 210. A way of doing this is described in relation to FIGS. 3 and 4.

Said first control unit 200 is arranged for adapting the control of the gas engine 210 based on the determined specific gas constant and the determined stoichiometric air fuel ratio. Said adapting the control of the gas engine 210 can comprise adapting the amount of fuel injected into the gas engine 210. This is in one example done by adapting tᵢₙⱼ. Said adapting the control of the gas engine 210 can comprise adapting the amount of air injected into the gas engine 210. This is in one example done by adapting the amount of air which can pass the throttle 260. This is in one example done by controlling the throttle flap. Said adapting the control of the gas engine 210 can comprise adapting the control of an exhaust gas recirculation, EGR (not shown). Said adapting the control of the gas engine 210 can comprise adapting a time of ignition in a cylinder of the gas engine 210. A person skilled in the art will realize that the control of a gas engine can relate to other parameters then those named here.

Adapting the control of the gas engine 210 based on the stoichiometric air fuel ratio and the specific gas constant of the fuel gas allows minimizing fuel consumption and emissions. It also allows increasing drivability of the gas engine 210. A further advantage of system 299 is that most or all of its components are present in nowadays vehicles. The present invention can thus be applied to present vehicles via software updates, without the need of any new hardware arrangements.

It should also be understood that one or more of the measured parameters which are described in this application can instead be estimated or pre-determined. This is especially useful when the component of the system 299 which corresponds to measuring the parameter is not present at a present vehicle. Said estimation can, for example, be performed by said first control unit 200. Said estimation can, for example, be based on measurement results from the remaining sensors and/or a model of the fuel/air/engine system in the corresponding vehicle.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as adapting engine control of a gas engine in a vehicle. The innovative method may be conducted by the first control unit 200 or the second control unit 205, or by both of them.

In FIG. 3 a flowchart of an example of a method 300 for adapting engine control of a gas engine in a vehicle is schematically illustrated. The method starts with an optional step 310. It should be emphasized that the steps of the method 300 not necessarily have to be performed in the order at which they are presented. The order of the steps is only limited in so far that one step might need the result of another step as input. Where this is not the case, the steps might be performed in any order, or in parallel.

In the optional step 310 measurements are performed in the vehicle 100. In one example, a measurement of pᵣₐᵢₗ is performed by said first pressure sensor 255. In one example, a measurement of Tᵣₐᵢₗ is by said first temperature sensor 254. In one example, a performed measurement of pᵢₙ is performed by said second pressure sensor 253. In one example, a measurement of Tᵢₙ is performed by said second temperature sensor 252. In one example, a measurement of λ is performed by said lambda sensor 250. In one example, a mass air flow is measured by said MAF-sensor 251. In one example the angle of a throttle flap of the throttle 260 is measured. In one example tᵢₙⱼ of said gas injector 270 is measured.

In relation to step 330 and to step 340 several alternatives will be described how the specific gas constant and/or AFRₛ can be determined. The measurements which are performed in step 310 are preferably adapted to which parameters are needed in the respective chosen way for determining the specific gas constant and/or AFRₛ. It should, however, also be understood that one or several of the needed parameters which will be described in relation to step 330 and step 340 can be pre-determined and, for example, stored in control unit. Alternatively, one or several of the needed parameters which will be described in relation to step 330 and step 340 can be determined based on one or several of the other measured parameters which are described here.

One such example is that a mass air flow measured by the MAF-sensor 251 can be replaced by determining the effective area of the throttle 260 and a measurement of the pressure and the temperature in the air inlet. This can be done via said third pressure sensor and said third temperature sensor. Determining the effective area of the throttle 260 comprises in one example measuring an angle of a throttle flap. In another example no measurement is performed for determining the effective area of the throttle 260. This can be achieved by sending a control signal to the throttle flap, where a specific control signal corresponds to a specific angle of the throttle flap. By knowing the control signal the angle of the throttle flap and thus the effective area can be derived without an additional measurement, see step 325.

Even the measurement of other of the parameters described in step 330 and step 340 can be replaced by assumptions and/or by deriving them from the measurement results of other measurements. After step 320 an optional step 320 is performed.

In the optional step 320 a time period of gas injection tᵢₙⱼ is determined. This is in one example done by measuring the time period of gas injection. In one example the time period of gas injection depends on a control signal which is sent from the first control unit 200 to the gas injector 270. The first control unit 200 can then derive tᵢₙⱼ from the control signal without the need of performing a measurement. The method continues with the optional step 325.

In the optional step 325 a flow of air into the gas engine is determined and/or a mass of air in a cylinder of the gas engine is determined. In one example this is done based on measuring the mass air flow with the MAF-sensor 251. In one example this is done via determining the effective area of the throttle. This has been described in more detail above, for example in relation to step 310. The method continues with step 330.

In step 330, during operation of the gas engine, the specific gas constant, R_{FG}, of the fuel gas for the gas engine is determined. This can be done based on the determined time period of gas injection in step 320. This can be done based on the result of one or more performed measurements, for example those described in relation to step 310. This can be done based on the determined flow of air into the gas engine and/or the determined mass of air in the cylinder of the gas engine as described in step 325.

In one example, the specific gas constant R_{FG} can be determined via the following relation:

$${R}_{FG} ∝ {( \frac{{p}_{in} {V}_{{FG}_{in}}}{{p}_{rail} {T}_{in} {t}_{inj} {A}_{CD} ψ} )}^{2} .$$

In one example equality is used in the above relation. In one example, one or several additional conversion constants are used in the above relation.

ψ is a nozzle flow factor, which in one example is a constant value. This is especially the case in a so-called sonic velocity regime where the pressure ratio pᵣ over the nozzle of the gas injector 270 is below a certain critical value p_{c}, wherein pᵣ=pᵢₙ/pᵣₐᵢₗ. In one example ψ depends on the pressure ratio over the nozzle pᵣ. This is especially the case in a so-called subsonic velocity regime where the pressure ratio pᵣ over the nozzle of the gas injector 270 is above the critical value p_{c}. Values for ψ, either constant values and/or values depending on pᵣ can be stored in the first control unit 200.

V_{FG}_{ᵢₙ} denotes the volume of the injected fuel gas and is in general dependent on the temperature and the pressure in the inlet manifold 230.

In one example, V_{FG}_{ᵢₙ} can be determined via the equation V_{FG}_{ᵢₙ}=(VE−VE_{FG})*V_{cyl}, wherein VE_{FG} denotes the volumetric efficiency of the gas engine when running on the fuel gas. In one example, VE_{FG} can be determined via the relation VE_{FG}=mₐᵢᵣ*Rₐᵢᵣ*Tᵢₙ/(pᵢₙ*V_{cyl}), where Rₐᵢᵣ is the specific gas constant of air and mₐᵢᵣ is the mass of air in the cylinder.

It should be understood that the above examples of how R_{FG}, V_{FG}_{ᵢₙ} and VE_{FG} can be determined are only presented for showing an enabling example of the present invention. There are different ways of determining R_{FG}, V_{FG}_{ᵢₙ} and VE_{FG}, for example by measuring different values and/or by deriving one or more of the values based on assumptions and/or information already present in the first control unit 200. Said deriving is in one example based on control signals. Said control signals can relate to components which are not present in FIG. 2 but well known in the art for constructing vehicles with gas engines. The present invention can thus be adapted to different kinds of vehicles with gas engines. The present step is performed during operation of the gas engine. The whole method can be performed during operation of the gas engine. This has the advantage that a driver does not need to wait for the method to be performed when driving and thus will not experience any negative effects of time delays or similar. Further, the method can in one example be performed at the vehicle alone. Thus, there is at this example no need to develop any interfaces to fuel stations or similar. The present method can thus be used with any fuel gas from any supplier without the need of additional investments for a supplier. Further, investments for vehicle constructors are neither needed since sensors and the like which are already present in the vehicle can be used. The method continues with step 340.

In step 340 the stoichiometric air fuel ratio AFRₛ of the fuel gas for the gas engine is determined. This can be done based on the determined time period of gas injection in step 320. This can be done based on the result of one or more performed measurements, for example those described in relation to step 310. This can be done based on the determined flow of air into the gas engine and/or the determined mass of air in the cylinder of the gas engine as described in step 325.

In the following, some examples are presented how AFRₛ can be determined:

$${AFR}_{S} = \frac{{R}_{FG}}{( \frac{VE}{{VE}_{FG}} - 1 ) λ \cdot {R}_{air}} , \\ {AFR}_{S} = \frac{{m}_{air} {R}_{FG} {p}_{in}}{{V}_{{FG}_{in}} λ \cdot {T}_{in}} , \\ {AFR}_{S} = {AFR}_{{S}_{ref}} \sqrt{\frac{{R}_{FG}}{{R}_{{FG}_{ref}}}} \frac{1}{{λ}_{c}} .$$

Some vehicles assume a reference fuel gas for a gas engine. This reference fuel gas has then an assumed reference stoichiometric air-fuel ratio AFRₛ_{_{ref}} and an assumed reference specific gas constant R_{FG}_{_{ref}}. A lambda controller in those vehicles usually produces a control factor λ_{c} for an actual fuel gas which is multiplied by a so-called fuel factor to achieve λ=1. For those vehicles the last of the above three equations can be used.

The above equations show that AFRₛ can be determined in a number of different ways. The above examples are not limiting and a person skilled in the art will realize that yet other equations can be used for determining AFRₛ. A suitable equation is preferably chosen based on which sensors are present in the vehicle and/or which values can be easily determined by a control unit in the vehicle. The method continues with step 350.

In step 350 the control of the gas engine is adapted based on the determined specific gas constant and based on the determined stoichiometric air fuel ratio.

Said adaption of the control of the gas engine comprises in one example adapting the amount of fuel injected into the gas engine. Said adapting of the control of the gas engine comprises in one example adapting tᵢₙⱼ. Said adapting of the control of the gas engine comprises in one example adapting the amount of air injected into the gas engine. This is in one example done by controlling the throttle flap. Said adapting of the control of the gas engine can comprise adapting the control of an exhaust gas recirculation, EGR. Said adapting the control of the gas engine can comprise adapting a time of ignition in a cylinder of the gas engine. Depending on the design of the gas engine there are other parameters as well which can be adapted. A person skilled in the art will be aware of which other parameters are present at a specific gas engine. Some advantages of the adaptions based on AFRₛ and R_{FG} are lower fuel consumption and/or lower amount of certain exhausts from the gas engine.

After step 350 the method ends.

The method or parts of the method can be performed repeatedly. As an example, none of the steps 300-340 does affect driveability of the vehicle. These steps can thus be performed at pre-determined time intervals or continuously. Even step 350 can be performed at pre-determined time intervals or continuously. An adaption in step 350 can be made dependent on that a determined AFR_{S} and/or a determined R_{FG} differs from a previously assumed or determined AFR_{S} and/or R_{FG} with more than a predetermined threshold. In one example, an average of AFR_{S} and/or a R_{FG} is taken over different runs of the steps 310-340 before step 350 is performed. In one example the method is performed when a refuelling of the gas tank 220 is detected. In one example, AFR_{S} and/or R_{FG} are determined by different equations and an average value of AFR_{S} and/or R_{FG} is taken before step 350 is performed.

FIG. 4 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for adapting engine control of a gas engine in a vehicle.

The computer program P may comprise routines for determining, during operation of the gas engine, the specific gas constant of a fuel gas for the gas engine. This may at least partly be performed by means of said first control unit 200 controlling operation of any of the sensors 250-255, and/or the throttle 260, and/or the gas injector 270. Said specific gas constant may be stored in said non-volatile memory 520.

The computer program P may comprise routines for determining the stoichiometric air fuel ratio of the fuel gas for the gas engine. This may at least partly be performed by means of said first control unit 200 controlling operation of any of the sensors 250-255, and/or the throttle 260, and/or the gas injector 270. Said stoichiometric air fuel ratio of the fuel gas for the gas engine may be stored in said non-volatile memory 520.

The computer program P may comprise routines for adapting the control of the gas engine based on the determined specific gas constant and the determined stoichiometric air fuel ratio.

The computer program P may comprise routines for determining a time period of gas injection.

The computer program P may comprise routines for performing at least one measurement in the vehicle. Said at least one measurement can comprise at least one temperature measurement and/or at least one measurement of temperature. Said at least one measurement can comprise a measurement of a λ value. This may at least partly be performed by means of said first control unit 200 controlling operation of any of the sensors 250-255, and/or the throttle 260, and/or the gas injector 270. The result of said performed at least one measurement may be stored in said non-volatile memory 520.

The computer program P may comprise routines for determining a flow of air into the gas engine 210 and/or for determining a mass of air in a cylinder of the gas engine 210.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L210, L250-255, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A method for adapting engine control of a gas engine in a vehicle, the method comprising:
determining, during operation of the gas engine, a specific gas constant of a fuel gas for the gas engine;
determining a stoichiometric air fuel ratio of the fuel gas for the gas engine; and
adapting a control of the gas engine based on the determined specific gas constant and the determined stoichiometric air fuel ratio.

2. The method according to claim 1, wherein said determining of the specific gas constant and/or the stoichiometric air fuel ratio is based on a determined time period of gas injection.

3. The method according to claim 1, further comprising performing measurements in the vehicle, wherein said determining of the specific gas constant and/or said determining of the stoichiometric air fuel ratio is based on a result of said performed measurements.

4. The method according to claim 3, wherein said performed measurements comprise measuring a pressure value and a temperature value in the inlet.

5. The method according to claim 3, wherein said performed measurements comprise measuring a temperature value and/or a pressure value of the fuel gas upstream of a gas injector.

6. The method according to anyone of claim 3, wherein said performed measurements comprise measuring a λ value by means of a lambda sensor being provided downstream said gas engine.

7. The method according to claim 1, further comprising the step of determining a flow of air into the gas engine and/or determining a mass of air in a cylinder of the gas engine, wherein said determining of the specific gas constant and/or the stoichiometric air fuel ratio is based on said determined flow of air into the gas engine and/or said determined mass of air in the cylinder of the gas engine.

8. A system for adapting engine control of a gas engine in a vehicle, the system comprising:
means for determining, during operation of the gas engine, a specific gas constant of a fuel gas for the gas engine;
means for determining a stoichiometric air fuel ratio of the fuel gas for the gas engine; and
means for adapting a control of the gas engine based on the determined specific gas constant and the determined stoichiometric air fuel ratio.

9. The system according to claim 8, further comprising means for determining a time period of gas injection, wherein said means for determining the stoichiometric air fuel ratio of the fuel gas for the gas engine and/or said means for determining, during operation of the gas engine, the specific gas constant of a fuel gas for the gas engine are arranged for basing said determining of the stoichiometric air fuel ratio and/or said specific gas constant on said determined time period of gas injection.

10. The system according to claim 8, further comprising means for performing measurements in the vehicle, wherein said means for determining the specific gas constant and/or said means for determining the stoichiometric air fuel ratio are arranged to base the determining on a result of said performed measurements.

11. The system according to claim 10, wherein said means for performing measurements comprise means for measuring a pressure value and a temperature value in the inlet manifold.

12. The system according to claim 10, wherein said means for performing measurements comprise means for measuring a temperature value and/or a pressure value of the fuel gas upstream of a gas injector.

13. The system according to claim 10, wherein said means for performing measurements comprise a lambda sensor arranged downstream said gas engine, wherein the lambda sensor is arranged for measuring a λ value.

14. The system according to claim 8, further comprising further means for determining a flow of air into the gas engine and/or means for determining a mass of air in a cylinder of the gas engine, wherein said means for determining the specific gas constant and/or said means for determining the stoichiometric air fuel ratio are arranged for basing said determining of the specific gas constant and/or the stoichiometric air fuel ratio on said determined flow of air into the gas engine and/or said determined mass of air in the cylinder of the gas engine.

15. A vehicle, comprising a system for adapting engine control of a gas engine in a vehicle, the system comprising:
means for determining, during operation of the gas engine, a specific gas constant of a fuel gas for the gas engine;
means for determining a stoichiometric air fuel ratio of the fuel gas for the gas engine; and
means for adapting a control of the gas engine based on the determined specific gas constant and the determined stoichiometric air fuel ratio.

16. A computer program product stored on a non-transitory computer-readable medium, said computer program product for adapting engine control of a gas engine in a vehicle, wherein said computer program product comprises computer instructions to cause said at least one control unit to perform the following operations:
determining, during operation of the gas engine, a specific gas constant of a fuel gas for the gas engine;
determining a stoichiometric air fuel ratio of the fuel gas for the gas engine; and
adapting a control of the gas engine based on the determined specific gas constant and the determined stoichiometric air fuel ratio.

17. (canceled)

18. The computer program product according to claim 16, wherein said determining of the specific gas constant and/or the stoichiometric air fuel ratio is based on a determined time period of gas injection.

19. The computer program product according to claim 16, further comprising computer instructions to cause said at least one control unit to perform the following operation of performing measurements in the vehicle, wherein said determining of the specific gas constant and/or said determining of the stoichiometric air fuel ratio is based on a result of said performed measurements.

20. The computer program product according to claim 19, wherein said performed measurements comprise measuring a pressure value and a temperature value in the inlet.

21. The computer program product according to claim 19, wherein said performed measurements comprise measuring a temperature value and/or a pressure value of the fuel gas upstream of a gas injector.
